(19) United States
(12) Patent Application Publication
(10) Pub. No.: US 2007/0187188 A1
(43) Pub. Date: Aug. 16, 2007

(54) Bicycle hydraulic rim brake attachment system.

(76) Inventor: Michael James Poyzer, Nottingham (GB)

Correspondence Address: MICHAEL JAMES POYZER, 299 A FOXHILL ROAD, CARLTON, NOTTINGHAM, NG4 1PX, GB

(21) Appl. No.: 11/613,242

(22) Filed: Dec. 20, 2006

(30) Foreign Application Priority Data
Jan. 6, 2006 (GB) 0600173.9

(51) Int. Cl. B62L 1/06

(52) U.S. Cl. 188/24.19

(57) ABSTRACT

A novel method of attaching a bicycle hydraulic rim braking system to a bicycle which allows it to accommodate a large variation in different bicycle wheel rim widths and still operate in an efficient manner.

### FIELD OF THE INVENTION

This invention is concerned with the method of clamping hydraulically operating rim brakes on to bicycle frames and forks. The invention provides a novel method of clamping those brakes on to frames and forks to allow for a larger variation of different bicycle wheel rim widths than the current methods.

### BACKGROUND TO THE INVENTION

Hydraulically operated rim brakes have been used now for several years on conventional pedal cycles and they are virtually all based on a closed hydraulic system. This has an operating master cylinder in the brake lever on the handlebar and a pair of matching slave cylinders mounted on the frame or fork either side of the bicycle wheel rim. Operation of the master cylinder forces the fluid down the pipes causing movement in each slave cylinder on which the brake pads are mounted, towards the wheel rim. When contact is made the resulting friction slows and stops the wheel. This arrangement requires fixing devices mounted on the frame or fork on which to attach the slave cylinders. These need to accommodate some up and down movement to suit slight variations in different rim braking surface diameters and also rotational movement to ensure brake pads can align along the periphery of the rim. A degree of pivoting is required to allow the pads to be parallel to the rim or to tow in at the front or back. Finally there is a degree of horizontal movement necessary to accommodate different rim widths. The maximum movement of the pad from rest to the rim is dictated by the diameter of the cylinder in the master and slave cylinder which is effected by the amount of fluid displacement and is typically about 5 or 6 mm. One of the most common methods of clamping these brakes specifically is the two-bolt type. This has two C shaped clamps place on opposite sides of the slave cylinder body with tabs top and bottom through which a bolt hole is drilled. A bolt, top and bottom secures the assembly to the pre welded, drilled and tapped frame or fork mounts. These “C” shaped brackets are identical top and bottom so can be reversed up or down with no effect. This system typically allows a maximum of about 10 mm of horizontal movement, thus allowing a rim width variation of approx. 20 mm. This situation was fine when rims varied between 20 mm and 40 mm. We now have requirements for rims up to 50 mm in width. This has meant that a frame manufacturer has to decide whether his frame or fork is designed to take either a wide rim or a narrow rim and adjust the position of the distance between the affixed brake mounts accordingly. It is alternatively an object of this invention to create a standard width which will be able to be laid down for these mounts which will accommodate any rim width between a maximum and minimum significantly greater than that available using current design. Once that standard width has been decided it will not be difficult to make modifications to the invention to accommodate even wider rims should they be required, without any variation of that standard width.

### SUMMARY OF THE INVENTION.

A bicycle frame or fork which is designed to accommodate hydraulically operated rim brakes as its prime braking method will normally have what is described here as two bolt fixings. These are effectively a welded on fitting (usually welded or brazed but could potentially be fitted by other means) on each stay of the frame or each leg of the fork. They are fitted adjacent to each side of the wheel rim and each of them accepts an upper and lower fixing bolt (usually 5 mm). They are positioned parallel to each other at a fixed distance. This fixed distance has to be varied depending on the width of the rim for which they are intended. The hydraulically operated slave cylinder which pushes the brake pad in and out is held on to this bracket by the said bolts. Two “C” shaped clamps with a top and bottom protrusion through which an elongated circular hole is machined circumscribes the circular body of the slave cylinder. A bolt then passes through each paired hole and secures the assembly to the frame or fork fitted bracket. The elongations are there to accommodate a degree of adjustment up and down. The pair of “C” shaped clamps are slightly different but broadly similar to each other but they are both identical top and bottom. This means that though one is a rear clamp and one is a front clamp, either of them could be positioned upside down without any difference in performance. According to the invention these “C” clamps are slightly varied to give the centre, half round section a degree of offset when compared to the centre line which passes down centrally through both the top and bottom elongated holes. This offset could be as little as 2 mm but the optimum amount is about 5 mm. This means that the clamp is no longer symmetrical and cannot be reversed top to bottom with no effect. This is the crux of the invention because it means that with both clamps set in one position the offset is to the outside and the brake pads can be thus set further away from the rim. If however you reverse the clamps top to bottom the offset is to the inside and the pads can be set further in. As stated previously the maximum sideways movement is normally about 10 mm. If the offset is fixed at the optimum 5 mm then the total available sideways movement is infinitely variable between a maximum and minimum of 20 mm giving a total, potential rim width variation of 40 mm. This would enable an industry standard bracket fixing width to be set for the brake carrying brackets to be attached, to accommodate any rim width.

### BRIEF DESCRIPTION OF THE DRAWINGS.

FIG. 1. is a front and side elevation of the frame stay tubes showing the position of the welded on brake carrying brackets

FIG. 2. is an isometric sketch of the current method used to affix the slave cylinder of the brake incorporating the brake pad, onto the frame or fork.

FIG. 3. is a side and front elevation of one “C” clamp forming half of the proposed brake fixing clamp.

FIG. 4. is a side and front elevation of the “C” clamp forming the other half of the proposed brake fixing clamp.

FIG. 5. is an exploded view of both “C” clamps and the two bolts and the bracket on the frame.

FIG. 6. is a view of brake fitted to cycle using existing type of “C” clamps.

FIG. 7. is a view of the same brake using proposed type of “C” clamps with offset to the outside.

FIG. 8. is a view of the same brake using proposed type of “C” clamps with offset to the inside.

### DETAILED DESCRIPTION OF THE DRAWINGS.

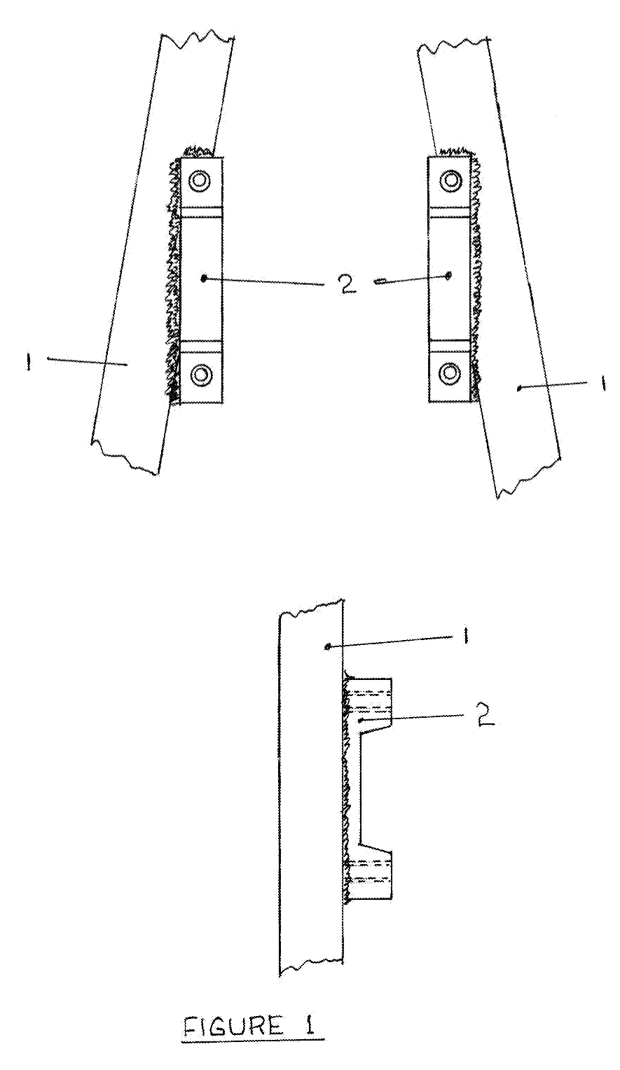

FIG. 1 is a front and side elevation of the frame stay tubes Item 1, showing the positioning of the welded on brake carrying bracket Item 2. Although the stays are on convergent paths to the top, as is shown, the brackets are welded on broadly parallel to each other and are therefore at an angle to the stays.

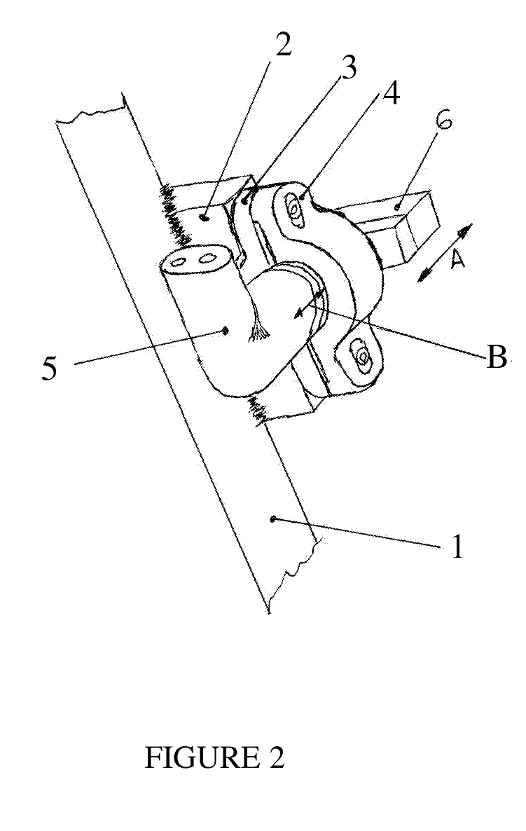

FIG. 2 is an isometric sketch of the current method used to affix the slave cylinder of the brake incorporating the brake pad, onto the frame or fork. Item 1 is the stay of the cycle frame and Item 2 is the bracket welded on to it for carying the brake. Items 3 and 4 are the existing type of “C” clamps which hold the Brake slave cylinder, Item 5. The Brake Pad, Item 6 moves in and out as per arrows A when the brake lever is operated. Arrows B indicate the adjustment of the slave cylinder within this type of “C” clamp.

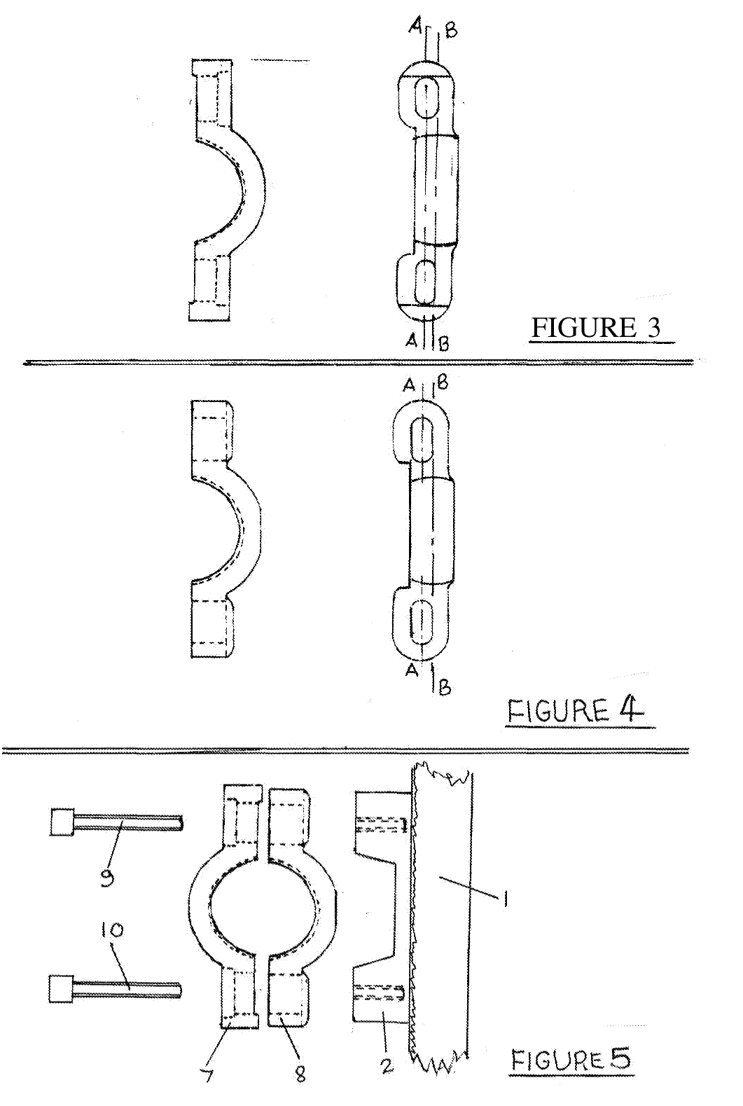

FIGS. 3 and 4 are side and end elevations of the proposed new design of “C” clamp. Centre line AA shown on both end elevations indicates the positioning of the elongated fixing bolt holes Centre line BB shown on both end elevations is the centre line of the slave cylinder holding portion of the “C” clamp and as shown is offset from centre line AA.

FIG. 5 is an exploded side view of the proposed “C” clamp assembly. Items 7 and 8 are the top and bottom “C” clamps which bolt together with bolts 9 and 10 to secure the slave cylinder (not shown) to Item 2 the welded on bracket.

FIGS. 6, 7 and 8 are views of the brake fully assembled on to the bicycle showing both side slave cylinders, Item 5 and both side Brake Pads Item 6. The 2 frame stays, Item 1 and the 2 carrying brackets Item 2 are indicated in all three drawings as are the piped flow of hydraulic fluid shown by arrows D.

FIG. 6 shows the current type of “C” clamp which as can be seen has the same centre line through the elongated holes and the central slave cylinder securing segment. A sectioned bicycle wheel rim is shown giving an indication of the potential width of that rim.

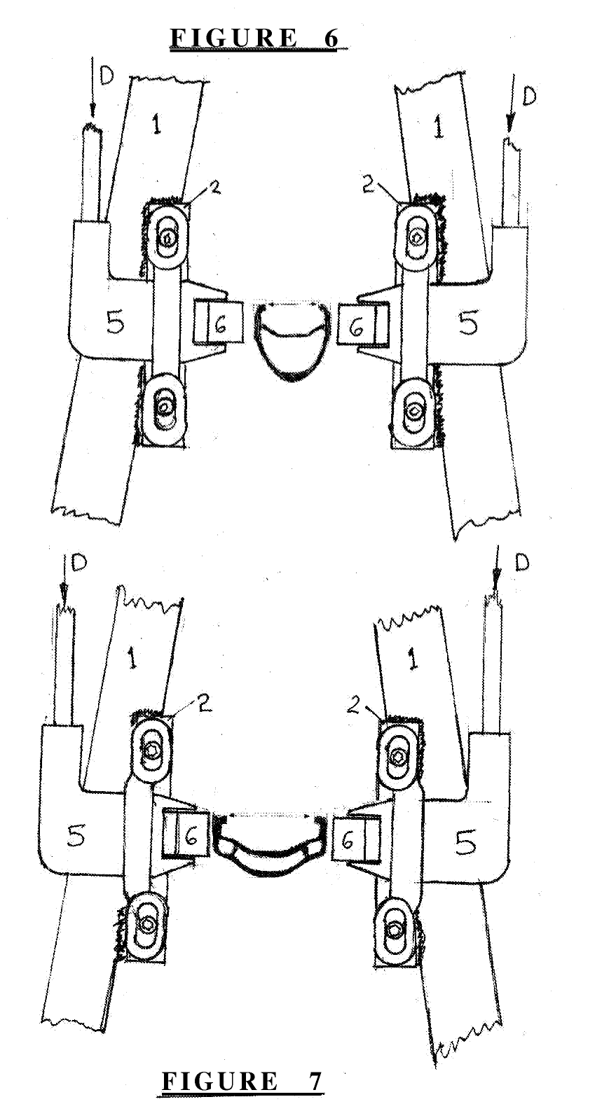

FIG. 7 shows the same assembly but this time using the proposed new “C” clamps with their offset to the outside of the frame. As can be seen by the sectioned wheel rim on this drawing, a much wider width of rim can be accommodated.

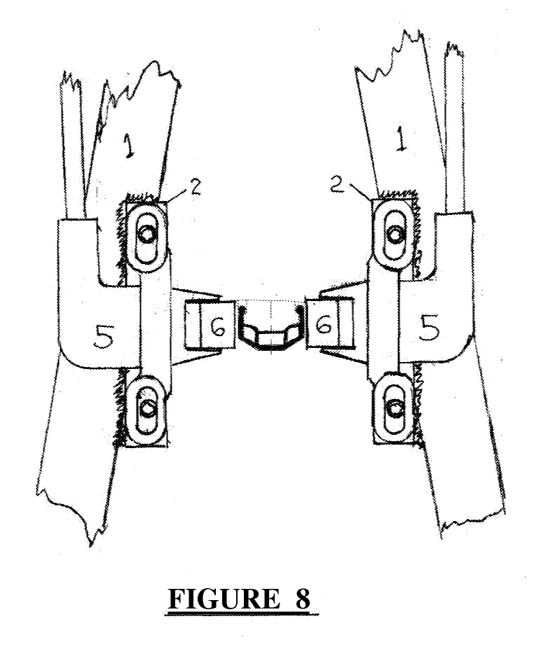

FIG. 8 shows the same assembly again but this time with “C” clamps reversed top to bottom so that the offset is to the inside of the frame. As can be seen by this, a much narrower rim than the original clamps allowed can be utilised.

1. A clamp designed to affix hydraulically operated rim brakes to a bicycle frame or fork which allows one fixng width between the fixing brackets to accommodate all possible available bicycle wheel rim widths and still operate efficiently as brake system.

2. A clamp as claim 1 which utilises a “C” clamp designed with an offset on the slave cylinder clamp section which makes the clamp reversible to vary the potential settings for a broader range of cycle rim widths.
